(19) United States
(12) Patent Application Publication
(10) Pub. No.: US 2024/0071248 A1
(43) Pub. Date: Feb. 29, 2024

(54) RECORDING MEDIUM, LEARNING GUIDANCE METHOD, AND LEARNING GUIDANCE DEVICE

(71) Applicant: JustSystems Corporation, Tokushima-shi (JP)

(72) Inventors: Kei SUZUKI, Tokyo (JP); Kentaro MATSUI, Tokyo (JP); Masahiro HATTORI, Tokyo (JP)

(73) Assignee: JustSystems Corporation, Tokushima-shi (JP)

(21) Appl. No.: 18/308,593

(22) Filed: Apr. 27, 2023

(30) Foreign Application Priority Data
Aug. 24, 2022 (JP) 2022-133698

(51) Int. Cl. G09B 7/04

(52) U.S. Cl. CPC G09B 7/04

(57) ABSTRACT

A computer-readable recording medium stores therein a program causing a computer to execute a process including: obtaining information related to a learning target and learning subjects from a user; calculating, based on the obtained learning target and learning subjects, a learning volume including a first learning time to complete learning the subjects within a total period and generating, based on the learning volume, a long-term learning plan including the first learning time for courses in each of the subjects; generating, for each course, a short-term plan in which, based on the generated long-term plan, a second learning time predicted for each course, for a period shorter than that of the long-term plan is calculated; presenting, to the user, the courses to learn daily; and calculating, in each predetermined period, a difference of the second learning time and an actual learning time, calculating, according to a learning status of the user, a third learning time necessary to complete the learning within the total period, and adjusting the courses in the short-term plan and the second learning time for each course.

### CROSS REFERENCE TO RELATED APPLICATIONS

This application is based upon and claims the benefit of priority of the prior Japanese Patent Application No. 2022-133698, filed on Aug. 24, 2022, the entire contents of which are incorporated herein by reference.

### BACKGROUND OF THE INVENTION

### 1. Field of the Invention

The embodiments discussed herein are related to a recording medium, a learning guidance method, and a learning guidance device.

### 2. Description of the Related Art

In online learning such as e-learning, efficient learning may be realized by conducting learning guidance where a learning plan matching the learning status of each user is set up.

As for technology related to such learning guidance, for example, there is a technology in which the number of right answers and wrong answers are counted by a right/wrong determination for each question attribute, weak-point attributes indicating there are less right answers or many wrong answers are recognized based on the count, and questions are selected from those of the weak-point attributes of the user (for example, see Japanese Laid-Open Patent Publication No. 2002-229431).

### SUMMARY OF THE INVENTION

According to an embodiment of the invention, a computer-readable recording medium stores therein a learning guidance program that causes a computer to execute a process, the process including: obtaining, at a time of starting learning, information related to a learning target and a plurality of learning subjects from a user; calculating, based on the obtained learning target and the obtained learning subjects, a learning volume including a first learning time to complete learning each of the subjects within a total period and generating, based on the learning volume, a long-term learning plan including the first learning time for a plurality of courses in each of the subjects; generating, for each of the courses, a short-term plan in which, based on the generated long-term plan, a second learning time predicted for each of the courses, for a predetermined period shorter than that of the long-term plan is calculated; presenting, to the user, the courses in the subject to learn daily, based on the short-term plan; and calculating, in each predetermined period, a difference of the second learning time and an actual learning time, calculating, according to a learning status of the user, a third learning time necessary to complete the learning within the total period, and adjusting the courses in the short-term plan and the second learning time for each of the courses.

Objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a system configuration diagram of a learning guidance system according to an embodiment.

FIG. 2 is a diagram depicting an example of a hardware configuration of a learning guidance device according to the embodiment.

FIG. 3 is a diagram depicting an example of an initial chat screen output by the learning guidance device.

FIG. 4A is a diagram depicting a screen example of a long-term plan output from the learning guidance device.

FIG. 4B is a diagram depicting a screen example of a short-term plan output from the learning guidance device.

FIG. 5 is a diagram depicting an example of a “today's learning screen” output from the learning guidance device.

FIG. 6 is a flowchart depicting processing examples of the learning guidance device at the time of initial activation.

FIG. 7 is a flowchart depicting a processing example of generating a short-term plan by the learning guidance device.

FIG. 8 is a flowchart depicting a processing example of presenting the “today's learning screen” by the learning guidance device.

FIG. 9A is a diagram depicting an example of a display screen at the time of adjusting a learning plan by the learning guidance device.

FIG. 9B is a diagram depicting an example of a display screen at the time of adjusting a learning plan by the learning guidance device.

FIG. 9C is a diagram depicting an example of a display screen at the time of adjusting a learning plan by the learning guidance device.

FIG. 10 is a flowchart depicting an example of adjustment processing on a learning plan by the learning guidance device.

FIG. 11 is a flowchart depicting an example of adjustment processing on a learning plan by the learning guidance device.

FIG. 12 is a diagram depicting an example of a chat screen of a response amendment function in the learning guidance device.

FIG. 13A is a diagram depicting an example of a chat screen for explaining a user's response supporting function in the learning guidance device.

FIG. 13B is a diagram depicting an example of a chat screen for explaining a user's response supporting function in the learning guidance device.

FIG. 13C is a diagram depicting an example of a chat screen for explaining a user's response supporting function in the learning guidance device.

FIG. 13D is a diagram depicting an example of a chat screen for explaining a user's response supporting function in the learning guidance device.

FIG. 14 is a flowchart depicting an example of a chat response amendment process performed by the learning guidance device.

FIG. 15 is a flowchart depicting a specific example of a chat response amendment process performed by the learning guidance device.

### DETAILED DESCRIPTION OF THE INVENTION

First problems related to the conventional technology are discussed. In the conventional technology, although it is possible to recognize a user's weak points to provide questions related to the weak points, longer-term learning targets cannot be set for each user and optimal learning guidance according to daily changes in each user's learning status cannot be made.

Embodiments of a recording medium, a learning guidance method, and a learning guidance device according to the present invention are described in detail with reference to the accompanying drawings.

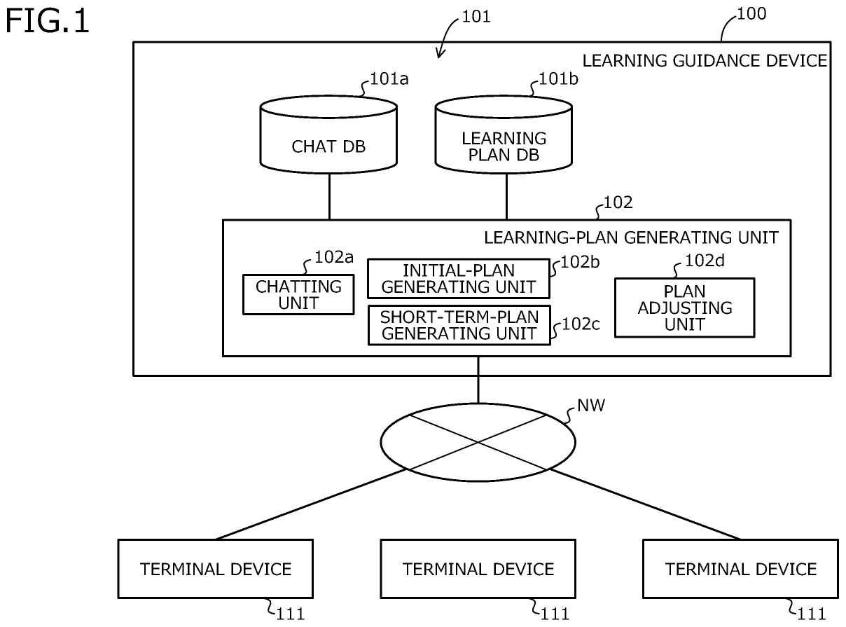

FIG. 1 is a system configuration diagram of a learning guidance system according to an embodiment. This learning guidance system includes a learning guidance device 100 and terminal devices 111 for each user, communicably connected to the learning guidance device 100 via a network NW.

The learning guidance device 100 includes multiple databases (DBs) 101 and a learning-plan generating unit 102. The terminal devices 111 are possessed by users who are learners. The terminal devices 111 may include smartphones, tablet computers, personal computers (PCs), and the like.

The learning guidance device 100 may be constituted of servers and the like. Further, a chatting unit 102a, an initial-plan generating unit 102b, a short-term-plan generating unit 102c, and a plan adjusting unit 102d as functional elements of the learning-plan generating unit 102 may be, respectively, implemented by individual servers and the like and configured to be able to access the DBs 101. In addition, the learning guidance device 100 may be provided on a cloud server.

The DBs 101A include a chat DB 101a and a learning plan DB 101b. The chat DB 101a stores therein information concerning contents of dialogues using a chat between the learning guidance device 100 and a user. The learning plan DB 101b stores therein information concerning learning plans presented to a user.

The learning-plan generating unit 102 accesses the chat DB 101a and the learning plan DB 101b and, for each of the terminal devices 111 belonging to the learning users, respectively, generates a learning plan with consideration of chat contents between the learning guidance device 100 and the corresponding user, and performs learning guidance to the user.

The chatting unit 102a makes a dialogue related to learning plans, with each of the users of the terminal devices 111. The chatting unit 102a makes a dialogue with the user on plan creation carried out by the initial-plan generating unit 102b, the short-term-plan generating unit 102c, and the plan adjusting unit 102d. The chatting unit 102a presents to the user, via a so-called “chatbot”, contents of inquiries (questions) that are set in advance. Further, the chatting unit 102a presents, to the user via the terminal device 111 belonging to the user, contents of replies (responses) from the user regarding the inquiry contents; the chatting unit 102a presents the contents with, for example, images such as stamps. In addition, in a case of responses to open-ended questions, the chatting unit 102a displays a text entry field and prompts user entry.

The initial-plan generating unit 102b performs, at the time of initial activation when a user starts learning, a hearing concerning the user's learning target and elective subjects through the chatting unit 102a and generates a long-term plan for the user according to results of the hearing.

The initial-plan generating unit 102b obtains, based on a chat with the user through the chatting unit 102a, information such as learning subjects, which are subjects that the user is going to learn, subjects the user want to work harder on, and a planned learning time for a week, and generates a long-term plan for each learning subject as an initial plan. The initial-plan generating unit 102b generates, based on a recommended pace of learning set in advance for each subject, a target schedule of a long-term plan for a total period within which all the learning is to be completed. The initial-plan generating unit 102b stores the generated long-term plan to the learning plan DB 101b.

The short-term-plan generating unit 102c generates, based on an initial plan (long-term plan) generated by the initial-plan generating unit 102b, a short-term plan for each predetermined period from the start of learning. The short-term-plan generating unit 102c stores the generated short-term plan to the learning plan DB 101b. For example, the total period of a long-term plan is one year and the predetermined period of a short-term plan is two weeks.

A short-term plan is, for example, a learning plan for a predetermined period (such as every two weeks) and is presented to a user. The short-term-plan generating unit 102c calculates a time allocation for each subject (hereinafter, “learning subject”) the user is going to learn in the next two weeks according to a short-term plan obtained by dividing the generated long-term plan. In this case, for example, the short-term-plan generating unit 102c increases the time allocation for “subjects to work harder on” as desired by the user. Further, the short-term-plan generating unit 102c adjusts the learning volume of each subject so that learning is completed within the time allocation, before a scheduled completion date and presents the plan as a short-term plan.

Each learning subject has multiple units as well as multiple courses below the layers of units. A unit is a collective set of courses. The short-term-plan generating unit 102c calculates a learning volume as a course presentation rate to be presented to a user. The short-term-plan generating unit 102c selects one or more courses to reach the course presentation rate, which is a lower limit threshold of the learning workload that should be ensured at minimum to maintain a learning effect.

When the course presentation rate is lower than the learning workload that should be ensured at minimum to maintain a learning effect, the short-term-plan generating unit 102c selects one or more courses so that the lower limit value of the course presentation rate is reached. In this case, although the completion date of learning is estimated to exceed the target period, the short-term-plan generating unit 102c prioritizes the effect of learning.

The learning guidance device 100 selects courses for one day from the short-term plan generated by the short-term-plan generating unit 102c and presents details of “today's learning” to the user of the terminal device 111. On a daily basis, the user learns the content of the courses displayed as “today's learning” on the screen of the terminal device 111. Thus, the user learns the content of the courses according to the learning plan generated by the learning guidance device 100 and, thereby, the user is able to complete learning within the prescribed total period and obtain a predetermined effect of learning.

The plan adjusting unit 102d performs a review process on actual results of the learning plan (actual status with respect to a predicted status) during the period (two weeks, as mentioned above) of each short-term plan generated by the short-term-plan generating unit 102c. For each short-term plan, the plan adjusting unit 102d collects learning statuses during the period of the short-term plan, calculates a learning pace record for the user, and predicts a completion date of learning a certain subject based on the learning pace record.

Thereafter, the plan adjusting unit 102d calculates the number of delayed days with respect to a prediction, when actual learning is delayed or the number of advanced days with respect to a prediction, when actual learning is ahead of schedule. When there is no delay, the plan adjusting unit 102d generates a short-term plan for the next two weeks. Meanwhile, when there is a delay, the plan adjusting unit 102d suggests the user to increase the daily learning time. If the user accepts the suggestion, the plan adjusting unit 102d generates a short-term plan for the next two weeks in which the planned learning time is increased (added).

The plan adjusting unit 102d presents the generated short-term plan for the next two weeks to the user. The learning plan DB 101b stores therein the two-week short-term plan generated by the short-term-plan generating unit 102c and updates the stored short-term plan with the plan adjusted by the plan adjusting unit 102d for the following two weeks as a short-term plan.

For example, the learning guidance device 100 generates a display screen of questions for learning and transmits the display screen to the terminal devices 111. Each of the terminal devices 111 displays the display screen generated by the learning guidance device 100, the user responds to the questions by operating the terminal device 111, and response results are transmitted to the learning guidance device 100.

The learning guidance device 100 according to the present embodiment makes an inquiry regarding a certain learning plan, from the chatting unit 102a to each user of the terminal devices 111, at timings such as generation of an initial (long-term) plan, generation of a short-term plan, and adjustment of a plan for the subsequent two week period. For example, by making an inquiry regarding the delay of learning, increase in learning time, and the like described above, the learning guidance device 100 adjusts the learning plan with consideration of the user's intentions and thereby performs efficient learning guidance.

In connection thereto, as a conventional technique, regarding adjustment of the learning plan, it is conceivable that, as a user designates the range and time of learning, a priority is judged under specified conditions and suitable questions are presented to the user. For example, it is conceivable that a range-specified workbook is generated and questions are adjusted so that these are answered within a certain time period (such as within 60 minutes). However, in such a technique, no learning plan for all the contents of a subject is generated and thus, there will be unlearned parts. Further, in such a technique, adjustment is made only on a learning plan for one time (such as one day) and adjustment on a learning plan in which learning is completed after a longer period of time (such as 12 months) cannot be made.

According to the learning guidance device 100 of the present embodiment, based on an initial (long-term) plan generated on an assumption of a relatively long-term learning plan having a total period such as one year, short-term plans (such as a plan for two weeks) is generated and a review of actual results is made every two weeks. With this process, by adjusting the learning plan at each shorter predetermined period with the assumption of learning over a certain total period by which predetermined learning results are gained, efficient learning guidance may be performed.

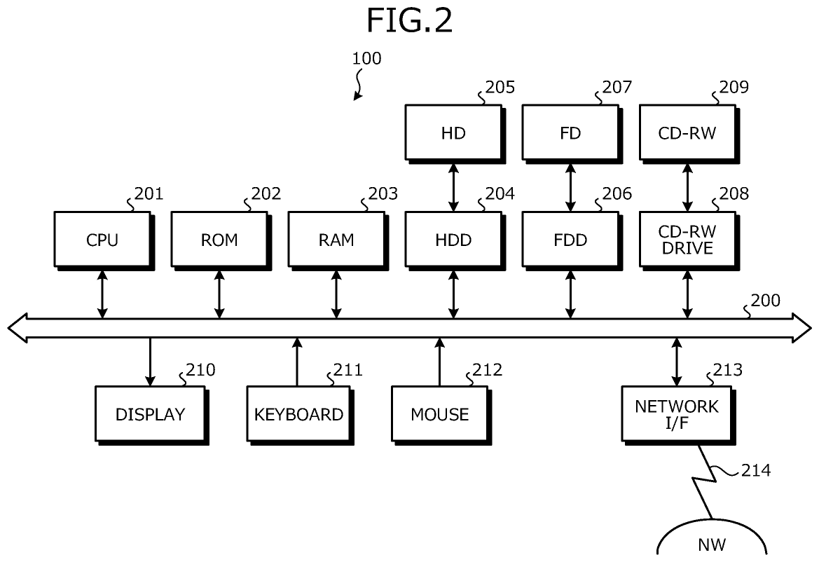

FIG. 2 is a diagram depicting an example of a hardware configuration of the learning guidance device according to the present embodiment. For example, the learning guidance device 100 depicted in FIG. 1 has the configuration depicted in FIG. 2. In FIG. 2, reference numeral 201 is a central processing unit (CPU) configured to function as a control unit the governs overall control of the device. Reference numeral 202 is a read-only memory (ROM) having a basic input/output program stored therein, and reference numeral 203 is a random access memory (RAN) used as a work area of the CPU 201.

Reference numeral 204 is a hard disk drive (HDD) that, under the control of the CPU 201, controls the reading and writing of data with respect to a hard disk (HD) 205 and the HD 205 stores therein the data written thereto under the control of the HDD 204.

Reference numeral 206 is a flexible disk drive (FDD) that, under the control of the CPU 201, controls the reading and writing of data to a flexible disk (FD) 207 and the FD 207 is a detachable FD that stores therein the data written thereto under the control of the FDD 206.

Reference numeral 208 is a compact disc-rewritable (CD-RW) drive that, under the control of the CPU 201, controls the reading and writing of data with respect to a CD-RW 209 and the CD-RW 209 is a detachable CD-RW that stores therein the data written thereto under control of the CD-RW drive 208.

Reference numeral 210 is a display that displays thereon a cursor, menus, windows, or various data such as letters and image; reference numeral 211 is a keyboard having keys to input letters, numerals, various instructions, and the like; and reference numeral 212 is a mouse for performing selection and execution of various instructions, selection of items to be processed, movement of a mouse pointer, and the like.

Reference numeral 213 is a network I/F that is connected to a network NW such as a local area network (LAN) or a wide area network (WAN) via a communication cable 214 and functions as an interface between the network NW and the CPU 201, and reference numeral 200 is a bus that connects the described components with one another.

In addition to the components described above, recording media such as a digital versatile disc (DVD) drive, a solid state drive (SSD), and a flash memory may be also used.

The learning guidance device 100 depicted in FIG. 1 implements functions thereof by executing predetermined programs on the CPU 201 using programs and data stored in the ROM 202, the RAM 203, the hard disk 205, the flexible disk 207, and the like depicted in FIG. 2. The DBs 101 depicted in FIG. 1 implement functions thereof using the ROM 202, the hard disk 205, the flexible disk 207, and the like depicted in FIG. 2.

Further, each of the terminal devices 111 depicted in FIG. 1 may be also constituted by hardware similar to that depicted in FIG. 2. When the terminal devices 111 are mobile devices such as a tablet computer, a smartphone, or the like, for example, a flash memory may be used instead of the hard disk 205 and the flexible disk 207, and a touch panel may be used as the display 210, the keyboard 211, and the mouse 212.

As described above, a “coaching function” executed by the learning guidance device 100 refers to a user's learning target and learning status in a dialogue with the user and presents a plan. Further, by presenting the most suitable plan corresponding to the user's daily learning status, efficient learning that enables the user to learn without concern is realized. To implement this function, the learning guidance device 100 according to the present embodiment performs the following learning guidance processes 1 to 3.

1. Process at Initial Activation

The learning guidance device 100, at initial activation, conducts a hearing with a user regarding a learning target and elective subjects to generate an initial plan (a long-term plan) tailored to the user.

2. Presenting Today's Learning Contents

The learning guidance device 100 presents, for each day, one or more courses to be done (today's learning contents) based on the initial plan (a short-term plan).

3. Learning Plan Adjustment

The learning guidance device 100 reviews actual results with the user, at predetermined periods (such as every two-weeks) and adjusts the contents of the short-term plan according to the user's learning status.

By this series of processes and by automatically adjusting the volume and the pace of courses even if there is inconsistency in the user's learning workload, the learning guidance device 100 enables the user to complete learning within the total period, which has a scheduled completion date of the learning.

Further, when learning is not completed within a targeted total period, on the assumption of gaining a predetermined effect of learning, the learning guidance device 100 may adjust the total period to be extended according to the learning workload of the user.

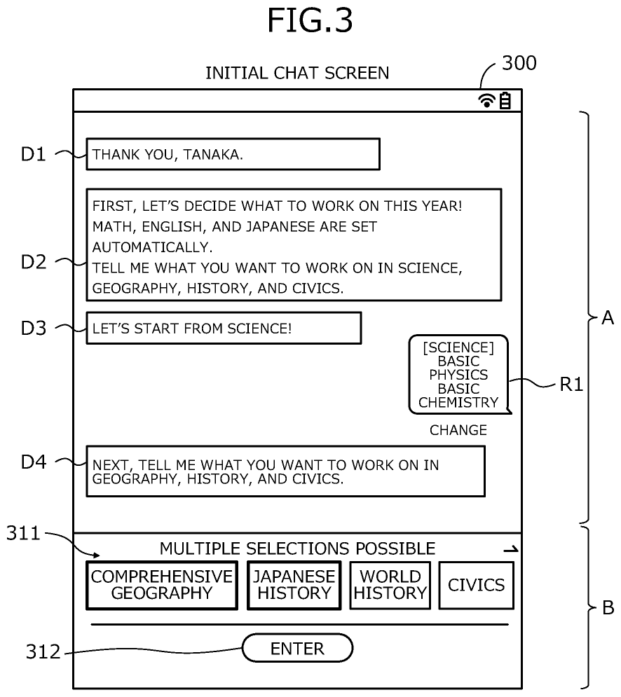

FIG. 3 is a diagram depicting an example of an initial chat screen output by the learning guidance device. FIG. 3 depicts an example of various screen displays to be displayed on the terminal device 111, based on transmission of information from the learning guidance device 100. In the following descriptions, the terminal device 111 is a smartphone and an example of a display screen on the smartphone is depicted.

At the time of initial activation when a user starts learning, the learning guidance device 100 conducts a hearing with the user regarding the learning status of the user and a learning target, via a chat UI through an initial chat screen 300 and generates an initial plan. The learning guidance device 100 then follows procedures and questions set in advance to automatically conduct a hearing with the user regarding learning, via a chatbot of the chatting unit 102a.

In the example depicted in FIG. 3, the learning guidance device 100 displays, as the initial chat screen 300, a chat area A and a response area B for the user. The learning guidance device 100 displays contents of each question regarding a user confirmation (D1), a learning confirmation of subjects listed in a predetermined order (D2), and a subject confirmation (D3) of a certain subject “science” in the chat area A. The user confirms the confirmation contents D1 to D3 through questions in a chat and enters intended courses (R1) as responses. Here, regarding “science”, the user enters the courses: basic physics and basic chemistry.

Subsequently, the learning guidance device 100 performs a learning confirmation (D4) of the next subject “geography, history, and civics”. Meanwhile, as is shown in the response area B, the learning guidance device 100 displays courses users can select in images (stamps 311) and the user's response contents in the chat area A may be easily selected with the user's selection of the stamps 311 and manipulation of an enter button 312.

The learning guidance device 100 obtains, from the user via the initial chat screen 300, information such as “user name or nickname”, “subjects to learn”, “subjects to work harder on”, “planned learning time for a week (such as 60 minutes on Sunday and 30 minutes on Monday)” as information for generating an initial plan. Further, the learning guidance device 100 may also obtain other types of information used for generating a learning plan such as “favorite subjects”, “weak subjects”, “level of college user hopes to enter”, “target scores in regular exams”, and “schedule of regular exams”.

The learning guidance device 100 generates a learning plan for each learning subject based on information obtained from the user via the initial chat screen 300. The learning guidance device 100 first generates a long-term plan as a learning plan including a total target schedule for each subject. The learning guidance device 100 then generates a short-term plan as a list of courses to be taken in the proximate two weeks, based on the generated long-term plan.

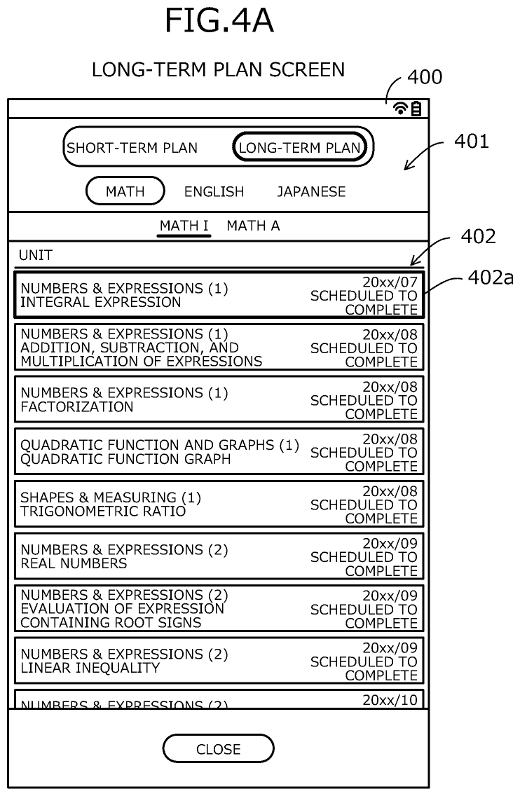

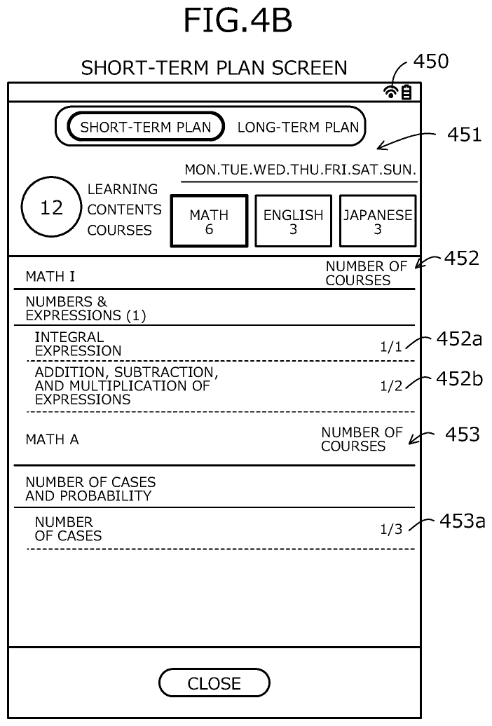

FIG. 4A is a diagram depicting a screen example of a long-term plan output from the learning guidance device. The learning guidance device 100 displays plan items 401 including learning plans, subjects, and courses in the upper part of a long-term plan screen 400. The plan items 401 in FIG. 4A represent an example where the learning plan is “long-term plan”, the subject is “math”, and the course is “math I”. Each unit item 402 included in the subject and course is displayed on the lower part of the plan items 401. For example, in one unit “numbers and expressions (1) integral expression” 402a, a scheduled completion date “July/Year 20xx” is displayed and contents of each unit item are displayed in the order of courses to be taken.

A long-term plan is set with an initial value based on a predetermined recommended learning pace, such as 10 months for “math I”. The initial value indicated by the long-term plan corresponds to a target schedule (a total period) and, at the time of plan adjustment, the learning guidance device 100 performs adjustment such that learning is completed within the total period of the target schedule (10 months). Further, as for the order of unit courses to be taken, the learning guidance device 100 decides an initial value according to a predetermined recommended curriculum and sets a planned period (a scheduled completion date) for each unit.

FIG. 4B is a diagram depicting a screen example of a short-term plan output from the learning guidance device. The learning guidance device 100 displays, in the upper part of a short-term plan screen 450 to be output to the terminal devices 111, a learning plan “short-term plan” as a plan item 451, the number of courses within the period (two weeks) of the short-term plan, and the number of courses of each subject. In the example depicted in FIG. 4B, the number of courses “12” within the period (two weeks) of the short-term plan of the plan item 451 as well as “6” for math, “3” for English, and “3” for Japanese as the number of courses of each subject are displayed.

In the lower part of the plan item 451, a unit item 452 of a subject (“math” is selected in the example depicted in FIG. 4B) selected in the plan item 451 is displayed. Further, a unit “numbers and expressions (1)” 452a included in the subject “math I” and contents of “addition, subtraction, and multiplication of expressions” 452b are displayed. Furthermore, contents of a unit “numbers of cases” 453a included in a unit item 453 of a subject “math A” are displayed.

As for a short-term plan, the learning guidance device 100 calculates, based on the contents of a generated long-term plan, a pace that enables the user to learn all courses of a subject. However, according to the user's learning time, there may be a case where the courses cannot be completed within a certain period. In such a case, for example, the learning guidance device 100 may present, by “narrowing down courses to high-priority ones” and “switching courses to ones with good time efficiency”, a plan in which courses may be learned comfortably within a limited time and learning efficiency is minimally lost.

A screen for a long-term plan and a screen for a short-term plan output from the learning guidance device 100 to the terminal devices 111 may be switched by a user operation on the terminal devices. After generating a long-term plan and a short-term plan, the learning guidance device 100 generates today's learning screens and outputs the screens to the terminal devices 111. With this process, users start today's learning.

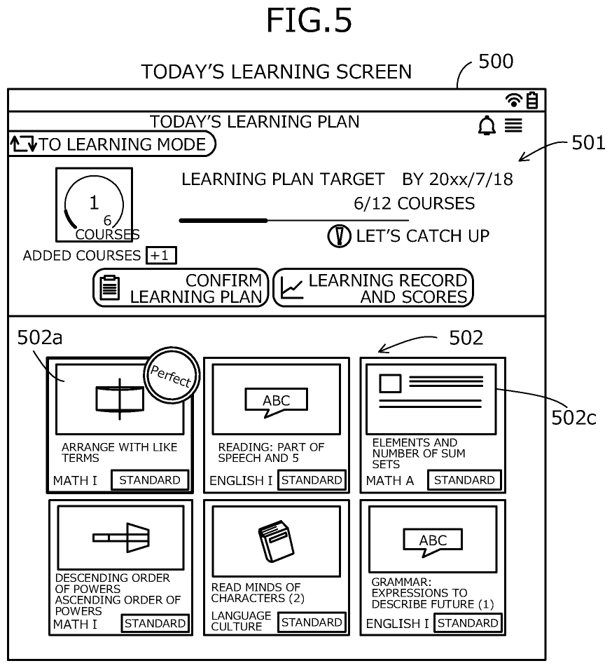

FIG. 5 is a diagram depicting an example of today's learning screen output from the learning guidance device. The learning guidance device 100 selects courses for one day from a short-term plan and outputs the courses to the terminal devices 111 as today's learning screen 500. Users may learn courses according to plan as they learn the content of the courses on the screen. Further, the learning guidance device 100 may suggest remedial courses according to the learning statuses of users.

In the example depicted in FIG. 5, in the upper part of the today's learning screen 500, the total number of courses “6” as today's learning item 501 and the number of finished courses “1” as well as the number of courses until a target date “July 18th, 20xx” as a learning plan and the number of finished courses “6” are displayed. Further, in the lower part on the today's learning screen 500, courses of the number to be learned today are displayed with icons 502. In the example depicted in FIG. 5, a total of six icons 502 are displayed. For example, an icon 502a is a unit “arrange with like terms” in the course “math I” and a sign “Perfect” indicating the course has been taken is displayed. An icon 502c indicates a unit “elements and number of sum sets” in the course “math A”.

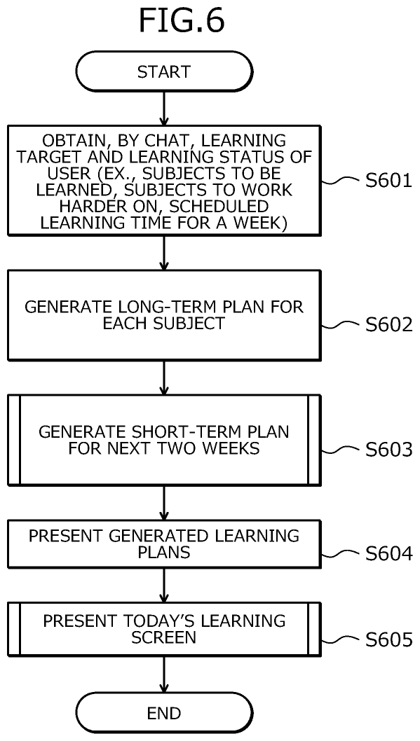

FIG. 6 is a flowchart depicting processing examples of the learning guidance device at the time of initial activation. Processing examples corresponding to the respective display screens in FIGS. 3 to 5 are described.

First, the learning guidance device 100 obtains a learning target and a learning status of a user in a chat on the initial chat screen 300 depicted in FIG. 3 (step S601). Next, the learning guidance device 100 generates a long-term plan for each learning subject, based the learning target and the learning status obtained from the user (step S602). At this time, the learning guidance device 100 generates a target schedule, based on a recommended pace.

Next, the learning guidance device 100 generates a short-term plan for a period such as the proximate two weeks (see FIG. 4B), based on the generated long-term plan (step S603). At this time, the learning guidance device 100 generates the short-term plan with consideration of a planned learning time for a week and the user's “subjects to work harder on”.

Next, the learning guidance device 100 presents the generated learning plans (the long-term plan and the short-term plan) to the user (step S604). The user may selectively display the long-term plan and the short-term plan via an operation on the terminal device 111.

Next, the learning guidance device 100 presents the today's learning screen (FIG. 5) to the user based on the generated short-term plan (step S605). The user can start learning according to the today's learning screen displayed on the terminal device 111.

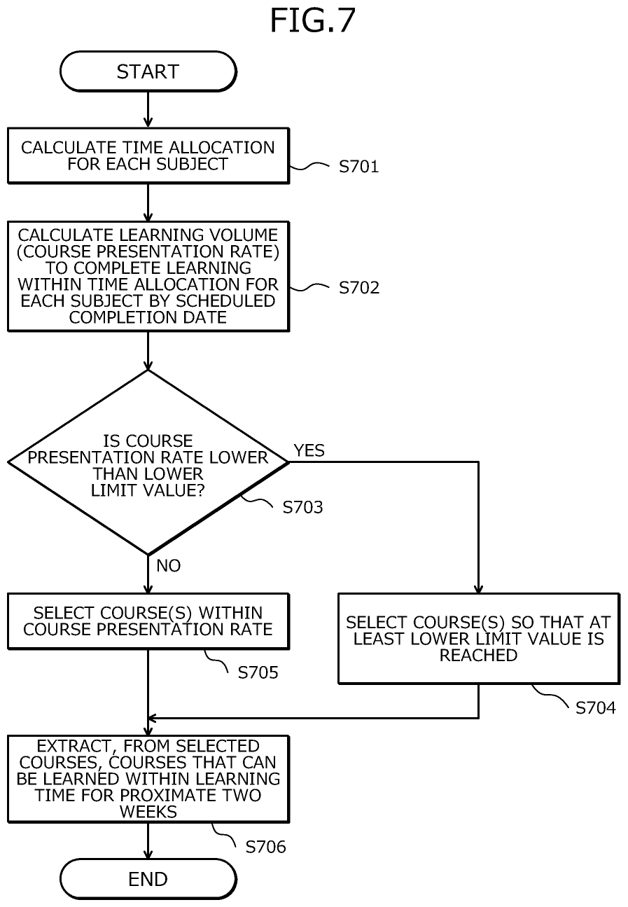

FIG. 7 is a flowchart depicting a processing example of generating a short-term plan by the learning guidance device. FIG. 7 is a detailed example of the process at step S603 in FIG. 6 and, for example, depicts an example of generating a short-term plan for the next two weeks after initial activation.

First, the learning guidance device 100 calculates a time allocation for each subject in a short-term plan for two weeks, based on the generated long-term plan (step S701). At this time, the learning guidance device 100 increases a time allocation for subjects designated by the user as “subjects to work harder on”.

Next, the learning guidance device 100 calculates a learning volume (a course presentation rate) for completing learning within the time allocation for each subject before a scheduled completion date (step S702). Thereafter, the learning guidance device 100 determines whether the course presentation rate is lower than a lower limit value (step S703). The lower limit value is set in advance according to a learning workload that should be ensured at minimum to maintain a learning effect.

As a result of the determination at step S703, when the course presentation rate is lower than the lower limit value (step S703: YES), the learning guidance device 100 proceeds to the process at step S704. Meanwhile, as a result of the determination at step S703, when the course presentation rate is not lower than the lower limit value (step S703: NO), the learning guidance device 100 proceeds to the process at step S705.

At step S704, the learning guidance device 100 selects a course(s) so that the course presentation rate is at least the lower limit value of (step S704), and proceeds to the process at step S706. With the process at step S704, although the completion date of learning (a total period) is estimated to pass an original target date, effect of learning is prioritized.

At step S705, the learning guidance device 100 selects one or more courses within the course presentation rate (step S705), and proceeds to the process at step S706. Meanwhile, at the time of initial activation, there is no accumulated data so that in the process at step S705, a course is selected based on, for example, information concerning priority and the like of each course.

At step S706, the learning guidance device 100 extracts, from among selected courses, courses that may be taken within the learning time in the proximate two weeks (step S706). Thereafter, the learning guidance device 100 proceeds to the process at step S604 in FIG. 6.

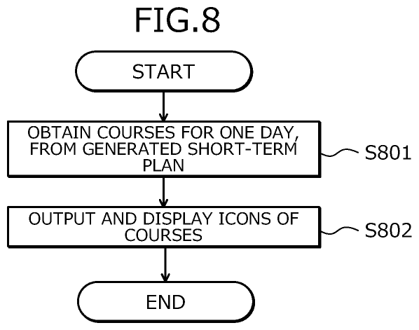

FIG. 8 is a flowchart depicting a processing example of presenting the today's learning screen by the learning guidance device. FIG. 8 is a detailed example of the process at step S605 in FIG. 6. First, the learning guidance device 100 obtains courses for one day from a generated short-term plan (step S801). Next, the learning guidance device 100 outputs and displays, on the terminal device 111, icons of the obtained courses for one day (see FIG. 5) (step S802) and ends the processing.

Users may learn courses according to the learning plan by learning the courses indicated by the icons 502 displayed on the today's learning screen on the terminal device 11.

The learning guidance device 100 makes learning plan adjustment in each period (such as two weeks) of a short-term plan. The learning guidance device 100 performs a review process on actual results of a learning plan (an actual status with respect to a predicted status) in each period (such as two weeks) of a generated short-term plan. Here, the learning guidance device 100 evaluates actual results in the following three viewpoints a to c.
a. Presentation of learning record in each period (two weeks) of short-term plan
b. Achievement evaluation on actual results of learning plan
c. Presentation of actual results at learning pace

In the processes for a to c mentioned above, the learning guidance device 100 inquires about the learning status of the user through conversations using a chat UI and confirms user intentions such as the user wanting to increase or decrease the learning workload. Subsequently, the learning guidance device 100 generates (updates) a short-term plan for the next two weeks based on information heard from the user and the actual learning status of the user.

Thereafter, the learning guidance device 100 repeats the processes for 2. Presenting today's learning contents and 3. Learning plan adjustment mentioned above. With this procedure, the learning guidance device 100 proceeds learning while adjusting the learning plan in each short-term plan (two weeks).

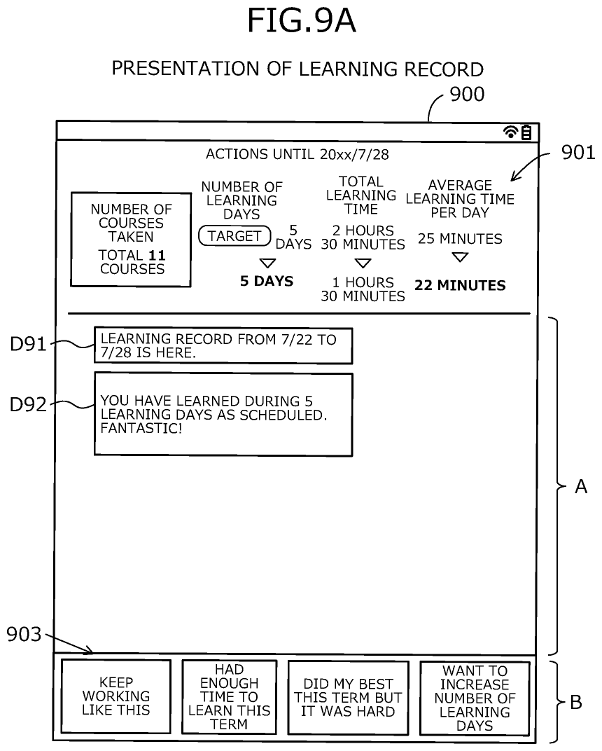

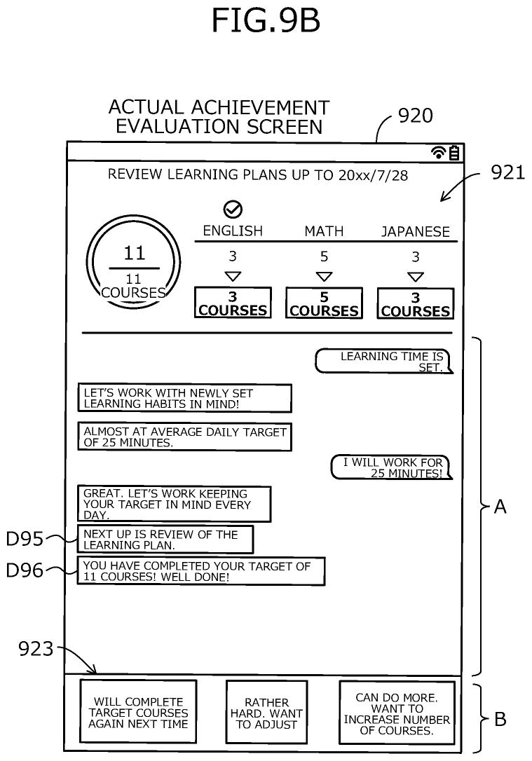

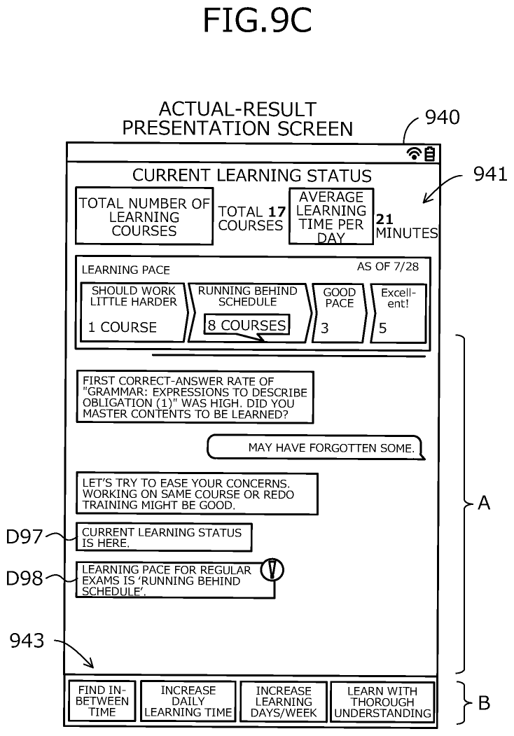

FIGS. 9A, 9B, and 9C are diagrams depicting examples of a display screen at the time of adjusting a learning plan by the learning guidance device. The learning guidance device 100 displays a learning-record presentation screen 900 on the terminal devices 111 of users in the order of FIG. 9A, FIG. 9B, and FIG. 9C.

FIG. 9A depicts an example of a display screen in a. Presentation of learning record in each period (two weeks) of short-term plan mentioned above. The learning guidance device 100 displays, as learning record items 901 in the last two weeks, the number of courses taken, a target (a schedule), and an actual learning status (an actuality) in the upper part of the learning-record presentation screen 900.

In the example of the learning record items 901 depicted in FIG. 9A, the learning guidance device 100 displays “11 courses” as the number of courses taken as well as “5 days” as planned learning days and “5 days” as actual learning days in a comparable manner. Further, the learning guidance device 100 displays “2 hours 30 minutes” as a planned total learning time and “1 hour 50 minutes” as an actual learning time as well as “25 minutes” as a planned average (learning) time in a day and “22 minutes” as an actual average (learning) time in a day in a comparable manner.

The learning guidance device 100 displays the chat area A in the lower part of the learning-record presentation screen 900. In the chat area A, chats of contents regarding a period (D91) of the displayed learning record and an evaluation (D92) regarding the learning record are displayed. Further, the learning guidance device 100 displays the response area B for a user regarding the chat-displayed record and multiple stamps 903 representing replies are displayed in the lowermost part of the learning-record presentation screen 900.

In the example depicted in FIG. 9A, the learning guidance device 100 displays examples of four expected replies, and the user may reply to the learning guidance device 100 concerning the learning status of the user in the last two weeks by selecting stamps. As these stamps, replies regarding increase and decrease of learning workload such as “keep working like this”, “had enough time to learn this time”, “did my best this time but it was hard”, and “want to increase the number of learning days” are prepared. The learning guidance device 100 uses the contents of replies on the stamps selected by the user and the actual learning status of the user to generate (update) a short-term plan for the next two weeks.

FIG. 9B depicts an example of a display screen in b. Achievement evaluation on actual results of learning plan mentioned above. The learning guidance device 100 displays the number of courses taken, a targeted (planned) number of courses to be taken in each subject, and an actual learning status (an actuality) as learning record items 921 in the last two weeks in the upper part on an actual achievement evaluation screen 920.

As for the learning record items 921 in the last two weeks depicted in FIG. 9B, the learning guidance device 100 displays “11 courses” as the number of courses taken as well as “3” as courses planned to be taken in a subject “English” and “3” as the number of courses actually taken in a comparable manner. Further, the learning guidance device 100 displays “5” as courses planned to be taken in a subject “Math” and “5” as the number of courses actually taken as well as “3” as courses planned to be taken in a subject “Japanese” and “3” as the number of courses actually taken in a comparable manner.

The learning guidance device 100 displays the chat area A in the lower part of the actual achievement evaluation screen 920. The upper part in the chat area A depicts a state in which chat contents from the start of a course until an actual achievement evaluation such as “learning time is set” and “let's work with newly set learning habits in mind” are displayed.

Subsequently, the learning guidance device 100 displays chat contents such as “Next up is review of learning plan (D95)” and “you have completed target 11 courses! Well done! (D96)” as actual achievement evaluation results of a learning plan. Further, the learning guidance device 100 displays stamps 923 representing replies from the user regarding the chat-displayed record in the response area B in the lowermost part of the actual achievement evaluation screen 920.

In the example of FIG. 9B, the learning guidance device 100 displays examples of three expected replies and the user may reply in response to actual achievement evaluation results of a learning plan by selecting stamps. As these stamps, replies regarding increase and decrease of learning workload such as “Will complete target courses again next time.”, Rather hard. Want to adjust”, and “Can do more. Want to increase number of courses.” are prepared. The learning guidance device 100 uses contents of replies on the stamps selected by the user and the actual learning status of the user to generate (update) a short-term plan for the next two weeks.

FIG. 9C depicts an example of a display screen in c. Presentation of actual results at learning pace mentioned above. The learning guidance device 100 displays, as a current learning status 941, “17 courses” as a total number of learning courses and “21 minutes” as an average learning time in a day, in the upper part of an actual-result presentation screen 940. Further, the learning guidance device 100 evaluates the current learning pace as a learning pace for each course in stages of achievement with a recommended learning pace as a benchmark and displays “Should work little harder (1 course)”, “Running behind schedule (8 courses)”, “Good pace (3 courses)”, and “Excellent (5 courses)”.

The learning guidance device 100 displays the chat area A in the lower part of the actual-result presentation screen 940. The upper part of the chat area A depicts a state where chat contents from the start of a course until presentation of an actual result such as “let's try to ease your concerns . . . ” are displayed.

Subsequently, the learning guidance device 100 displays chats such as “current learning status is here (D97)” and “learning pace for regular exams is ‘running behind schedule’ (D98)” as presentations of actual results of a learning plan. The learning guidance device 100 displays these chats because “8” courses, the largest number of courses, are slightly running behind the schedule in terms of achievement stages as shown on a screen of the current learning status 941. Further, the learning guidance device 100 displays, in the lower part of the actual-result presentation screen 940, stamps 943 representing replies from the user regarding the chat-displayed record.

In the example of FIG. 9C, the learning guidance device 100 displays examples of four expected replies and a user may reply to presentation of actual results of a learning plan by selecting stamps. As the stamps, replies regarding increasing and decreasing learning workload such as “find in-between time”, “increase learning time per day”, “increase learning days/week”, and “learn with thorough understanding” are prepared. The learning guidance device 100 uses the contents of replies on the stamps selected by the user and the actual learning status of the user to generate (update) a short-term plan for the next two weeks.

An example of learning plan adjustment is described next. Learning plan adjustment is not limited to 3. Learning plan adjustment mentioned above and is also performed in 1. Process at initial activation.

In the learning plan adjustment, the following processes 1) to 3) are performed.

### 1) Determine Time Allocation for Each Subject

The learning guidance device 100 allocates “planned learning time for a week” heard from the user in a chat according to the course volume of each subject. Here, the learning guidance device 100 increases the allocation of learning workload to “subjects to work harder on”. Further, the learning guidance device 100 makes adjustment so that a total learning amount is increased according to response contents in a review in the unit of two weeks, for example.

2) Calculation of Learning Volume in Each Subject (Course Presentation Rate)

The learning guidance device 100 provisionally calculates a learning volume that can be completed within a planned period in an allocated time for each subject and calculates an index “course presentation rate (regarding what percent of courses among all courses should be presented)”. For example, “course presentation rate: 70%” represents a state where a learning plan is completed within a planned period as long as 70% of courses in a total learning amount are taken.

As for the course presentation rate, an example of specific calculation is described. For example, in an initial plan, the learning guidance device 100 may calculate the course presentation rate by a formula “{allocated time for subject (minutes/week)×planned period (week) for subject}/total of required time for all courses (minutes)”.

Further, in a case of reviewing, a future learning workload is predicted with consideration of the learning pace in the past and adjustment is made such that a presented learning volume is decreased for users running behind their respective learning schedules. For example, the course presentation rate is calculated by a formula “course presentation rate=course presentation rate of initial plan×progression rate”. The progression rate is calculated by, for example, a formula “progression rate={(number of completed courses)/(number of total courses)}÷{(elapsed period (weeks))/(planned period for subject (weeks))}”. Various other methods may be used for the prediction of learning pace.

3) Select Course to be Presented According to Course Presentation Rate

When the course presentation rate is less than 100%, the learning guidance device 100 applies any one of the following conditions A to C to select a course to be presented. With this process, the learning volume is decreased while avoiding a large loss in effect of learning.

A. Selection Based on Priority Information Concerning Courses

The learning guidance device 100 attaches priority information as course-related meta information to each course in advance and narrows courses down to high priority courses (omits low priority courses).

B. Switching to Time Effective Courses

As the types of courses, in the learning guidance device 100,
a) courses that take time but provide in-depth understanding (example: normal courses) and
b) courses that require a short term and focus on general ideas (example: input videos and word cards) are prepared, and by switching courses from a) to b), gaining general ideas of a subject is prioritized and time saving is achieved.

C. Course Selection According to User's Learning Performance When the user's learning progresses and learning data of the user is accumulated, the learning guidance device 100 determines the user's learning performance based on the accumulated learning data. The learning guidance device 100 attaches “difficulty level” information as course-related meta information to each course in advance and prioritizes courses with a difficulty level matching the user's learning performance.

For example, “difficulty level” is set as course-related meta information.

“Basics” and “standard” are prioritized for users with less learning performance.

“Target” and “application” are prioritized for users with better learning performance.

The learning guidance device 100 may make adjustment by using different methods according to situations as described below. For example, there is assumed a case where a target score in a test is set to be 80 points. As for the learning pace, course selection is changed according to stages such as “fine”, “first stage (learning time is slightly decreased)”, “second stage (only making course adjustment is not enough to achieve target)”, and the final “third stage”.

For example, in a case of “fine”, the learning guidance device 100 presents high priority courses preferentially. Further, the learning guidance device 100 presents courses with a high target point or remedial courses according to the user's learning results. Next, at the “first stage”, because the user's learning time is slightly decreased, the learning guidance device 100 specifically presents courses where an effect of learning with respect to the user's learning target may be gained. Subsequently, at the “second stage”, because only making course adjustment is not enough to achieve the user's learning target, the learning guidance device 100 specifically presents courses where an effect of learning with respect to the user's learning target may be gained. Finally, at the “third stage”, the learning guidance device 100 makes a change to learning that gives the user general ideas of a subject even in a short time. Here, the objective is to make the user engage a full learning course to avoid a state in which the user works on questions that he has not been familiar with before, when preparing for regular tests and the like.

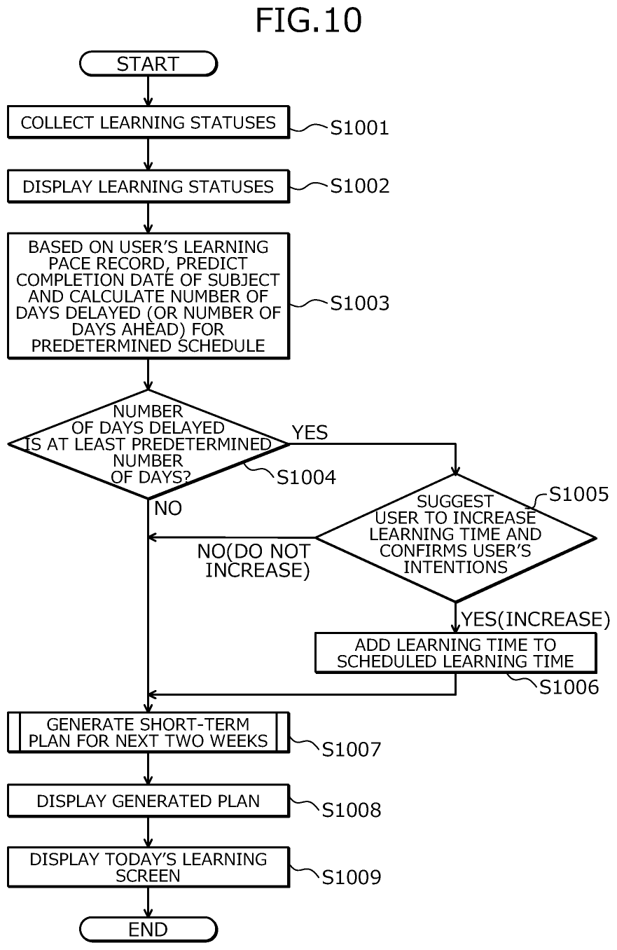

FIG. 10 is a flowchart depicting an example of adjustment processing on a learning plan by the learning guidance device. A processing example of adjusting a short-term plan with the above-described review of actual results in the unit of a predetermined period (such as two weeks) is described.

First, the learning guidance device 100 collects learning statuses (step S1001) and displays the learning statuses (step S1002). As the learning statuses, the learning guidance device 100 counts the number of courses taken, learning times, and the like and displays them for each period such as two weeks.

Next, based on the user's learning pace record, the learning guidance device 100 predicts a completion date of a subject and calculates the number of days delayed (or the number of days ahead) for a predetermined schedule (step S1003), and determines whether the number of days delayed is at least a predetermined number of days (step S1004).

When the number of days delayed is at least a predetermined number of days (step S1004: YES), the learning guidance device 100 proceeds to the process at step S1005. On the other hand, when the number of days delayed is not at least a predetermined number of days (step S1004: NO), the learning guidance device 100 proceeds to the process at step S1007.

At step S1005, the learning guidance device 100 suggests the user to increase his learning time and confirms the user's intentions (step S1005). For example, the learning guidance device 100 suggests the user to increase his learning time in the chat depicted in FIGS. 9A to 9C to confirm the user's intentions.

At step S1005, when it is confirmed that the user intends to increase the learning time (step S1005: YES), the learning guidance device 100 adds a learning time to a planned learning time (step S1006) and proceeds to the process at step S1007. On the other hand, when it is confirmed that the user does not intend to increase the learning time (step S1005: NO), the learning guidance device 100 proceeds to the process at step S1007.

At step S1007, the learning guidance device 100 generates a short-term plan for the next two weeks (step S1007). Next, the learning guidance device 100 displays the generated plan (the short-term plan) (step S1008). Further, the learning guidance device 100 displays today's learning screen based on the short-term plan generated at step S1007 (step S1009), and ends the processing described above.

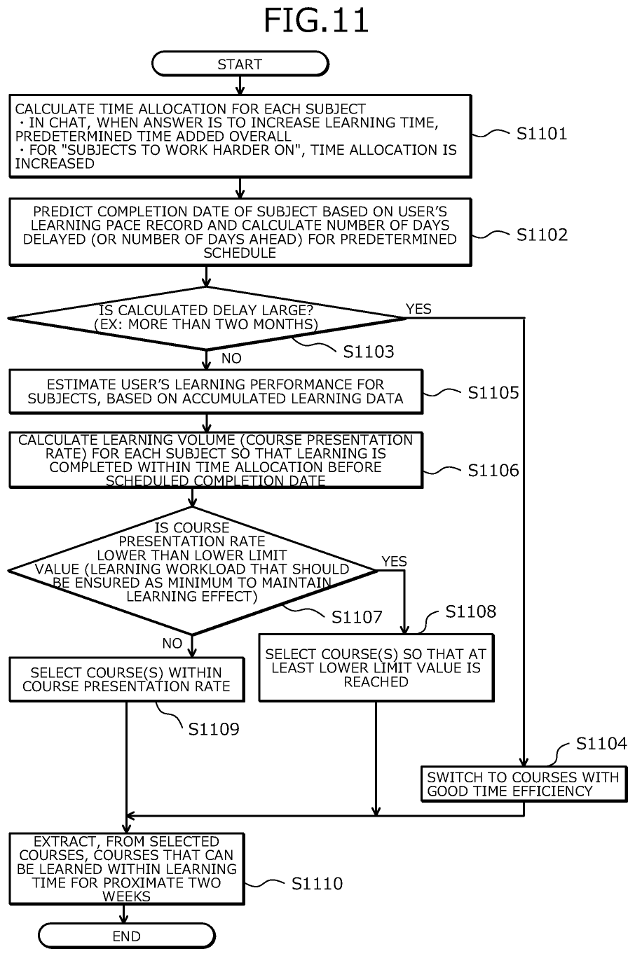

FIG. 11 is a flowchart depicting an example of adjustment processing on a learning plan by the learning guidance device. FIG. 11 is a detailed example of a generating process of a short-term plan for the next two weeks shown at step S1007 in FIG. 10.

First, the learning guidance device 100 calculates a time allocation for each subject (step S1101). For example, in a chat, when there is a response from the user indicating that the user intends to increase the learning time, the learning guidance device 100 adds a predetermined time to all courses. Further, regarding “subjects to work harder on”, the learning guidance device 100 increases the time allocation for the learning time through a chat.

Next, the learning guidance device 100 predicts the completion date of a subject based on the user's learning pace record and calculates the number of days delayed (or the number of days ahead) regarding a predetermined schedule (step S1102). The learning guidance device 100 then determines whether the calculated delay is large (such as delayed more than two months) (step S1103).

On the basis of the determination at step S1103, when the delay is large (step S1103: YES), the learning guidance device 100 switches courses to ones with good time efficiency (step S1104). When the delay is large, the learning guidance device 100 switches courses to ones that can be learned in a short time and focus on general understanding such as courses using input videos and word cards, thereby prioritizing general understanding and achieving time saving. Thereafter, the learning guidance device 100 proceeds to the process at step S1110.

On the basis of the determination at step S1103, when the delay is not large (step S1103: NO), the learning guidance device 100 estimates the user's learning performance for subjects, based on accumulated learning data (step S1105). Subsequently, the learning guidance device 100 calculates a learning volume (a course presentation rate) for each subject so that learning is completed within the time allocation before the scheduled completion date (step S1106). Here, as described above, the learning guidance device 100 makes a prediction of learning workload for the future based on the learning pace in the past and decreases a presented learning volume for users running behind their respective learning schedules.

Next, the learning guidance device 100 determines whether the course presentation rate is lower than a lower limit value (a learning workload that should be ensured at minimum to maintain a learning effect) (step S1107). As a result of determination at step S1107, when the course presentation rate is lower than the lower limit value (step S1107: YES), the learning guidance device 100 proceeds to the process at step S1108. On the other hand, when the course presentation rate is not lower than the lower limit value (step S1107: NO), the learning guidance device 100 proceeds to the process at step S1109.

At step S1108, the learning guidance device 100 selects a course so that the lower limit value of the course presentation rate is reached (step S1108) and proceeds to the process at step S1110. Here, although the course is estimated to exceed the completion date of learning, the learning guidance device 100 prioritizes an effect of learning.

At step S1109, the learning guidance device 100 selects one or more courses within the course presentation rate (step S1109) and proceeds to the process at step S1110. Here, in the process at step S1109, the learning guidance device 100 may attach “difficulty level” information as course-related meta information to each course in advance and preferentially select a course with a difficulty level matching the user's learning performance. For example, “difficulty level” is ranked in “basics”, “standard”, and “application” in ascending order, and courses of “basics” and “standard” may be preferentially selected for users with less learning performance and “standard” and “application” may be preferentially selected for users with better learning performance.

At step S1110, the learning guidance device 100 extracts a course to be completed within the learning time in the proximate two weeks from selected courses (step S1110) and ends the processing described above. Thereafter, the learning guidance device 100 proceeds to the process at step S1008 in FIG. 10.

As described above, the learning guidance device 100 generates and adjusts a learning plan with consideration of information obtained from a chat with the user. In the following descriptions, a function corresponding to amendment (changing) of responses the user has given in a chat is described.

The learning guidance device 100 displays questions in a dialogue format using a chat UI of the chatting unit 102a and decides contents in subsequent dialogues based on responses to the questions from the user (a scenario chatbot). Normally, a dialogue in a chat proceeds in one direction; however, there may be a case in which the user wants to change a response due to erroneous operations or temporary misunderstanding. In the response amendment function in a chat described below, specific responses posted in the past may be amended and the result of amendment is also reflected on already displayed contents in subsequent dialogues.

The user may check his amendment by scrolling a chat screen to return to the contents of past chats. Further, with a tap of a change button for a certain response by the user, the learning guidance device 100 may automatically scroll a chat history to the position where the corresponding question is displayed.

Conventionally, there are amendment functions for posted contents in an interpersonal chat and Undo functions for returning to one previous question with respect to a certain question in a chatbot. However, according to the chat response amendment function in the present embodiment, there are advantageous operational effects as follows.
a) A specific response posted in the past may be pinpointed alone and amended (changed).
b) The result of amendment is reflected on already displayed contents in subsequent dialogues.

Details of the above functions are described. As for the function that a) A specific response posted in the past may be pinpointed alone and amended (changed), when a user responds to a question, contents of the response are displayed as a dialogue of the user, and a “change button” is displayed on each dialogue response-balloon. As the user taps the change button, the chatting unit 102a of the learning guidance device 100 again displays options and the like including other responses enabling the user to respond to the question again, thereby enabling the user to update the response by selecting any of the options.

In the learning guidance device 100, there may be a case where, in order to change coaching contents due to the contents of dialogues in a chat, the user wants to amend a certain response given in the past when he realizes the need. Here, with a conventional Undo function, the procedure is to trace back questions in the past one by one or to respond to many questions again from the beginning. On the other hand, with the chat response amendment function of the learning guidance device 100 in the present embodiment, it is possible to amend only a certain question, so that the number of user operations may be reduced.

Next, as for the function that b) The result of amendment is reflected on already displayed contents in subsequent dialogues, when a response in the past has been amended, there will be discrepancies in a response from the chatbot side to the amended response and contents in subsequent dialogues. These discrepancies occur since a different response is given and the response from the chatbot side branches into a different scenario. With the response amendment function of the learning guidance device 100 in the present embodiment, contents of dialogues subsequent to the amended response are re-evaluated and the contents are automatically replaced with contents having the latest response reflected therein.

For example, it is assumed that, regarding a question “Do you want to increase your learning time?”, a user amends a previous response “I will not change my learning time” to “I will increase my learning time”. In this case, the chat of the learning guidance device 100 responds to the response “I will not change my learning time” as “let's find in-between time” and at this time suggests the user to increase his learning time. Thereafter, when the user amends the response to “I will increase my learning time”, the chat of the learning guidance device 100 responds to mention a target at the time of increasing the learning time as “let's work hard with the aim of increasing learning time”. In this manner, the learning guidance device 100 indicates each portion where dialogue contents have been replaced with animation and displays these portions so that how the original dialogue contents have changed due to response amendment is clearly shown.

According to the chat response amendment function described above, the learning guidance device 100 may immediately amend only necessary portions corresponding not only to recent erroneous operations made on the user side but also a misunderstanding realized as dialogues proceeded or a change of attitude. In this respect, in a conventional Undo function, all questions from a traced back portion have to be responded to again.

Further, according to the chat response amendment function described above, it is easy to recognize how the user's own response at the time of amendment is reflected on dialogues and any unnatural parts are not left in the dialogue contents. In addition, since amendment may be made after giving a response, the user will not feel any pressure when responding to each question and thus, dialogues may proceed smoothly.

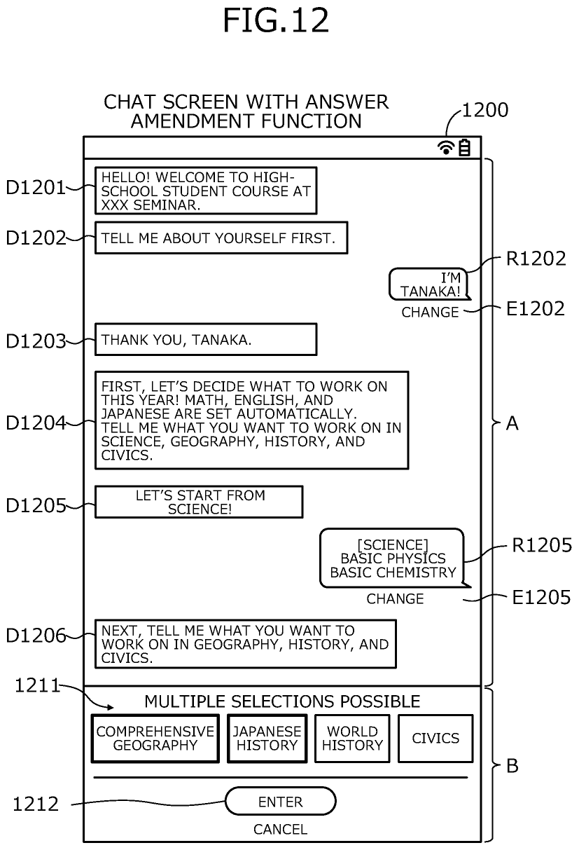

FIG. 12 is a diagram depicting an example of a chat screen of the response amendment function in the learning guidance device. FIG. 12 depicts an example of a chat screen 1200 having the response amendment function that the chatting unit 102a of the learning guidance device 100 displays on the terminal device 111 of a user.

On the chat screen 1200, the chat area A and the response area B for a user corresponding to the initial chat screen depicted in FIG. 3 are displayed. The chat screen 1200 represents chat contents corresponding to the initial chat screen depicted in FIG. 3, and the learning guidance device 100 displays inquiries (questions) regarding a course guide (D1201) and a user confirmation (D1202) on the chat area A.

The user inputs a user name “I am Tanaka!” R1202 as the user's response corresponding to the user confirmation D1202. Here, the learning guidance device 100 displays a change button E1202 “change” at a position right below the user's response R1202 and can amend the response R1202 with a tapping operation on the button “change” by the user at any timing after displaying the change button E1202.

The learning guidance device 100 displays a user name confirmation (D1203) by the user, a course guide (D1204), and a course selection confirmation (D1205) for each subject. Here, it is assumed that the user has given a response regarding a course “science” of the course selection confirmation (D1205) for each subject as “basic physics and basic chemistry” R1205. In this case, the learning guidance device 100 displays a change button E1205 “change” at a position right below the user's response R1205 and the response R1205 may be amended with a tapping operation on the button “change” by the user at any timing after displaying the change button E1205.

Thereafter, the learning guidance device 100 displays a course selection confirmation (D1206) for a next subject. Here, as shown in the response area B, the chatting unit 102a of the learning guidance device 100 displays a response regarding the course selectable by the user and the like in an image (a stamp 1211), and when the user selects the stamp 1211 and operates an enter button 1212, contents in each response R given by the user in the chat area A are selected easily. That is, regarding each inquiry D, the chatting unit 102a of the learning guidance device 100 displays expected responses R corresponding to the contents of the inquiry D as multiple stamps 1211 in the response area B.

With this configuration, regarding a course “geography, history, and civics” of the course selection confirmation (D1206) for each subject, as the user performs an operation to select “comprehensive geography” and “Japanese history” from the stamps 1211 and operates the enter button 1212, the user's response R corresponding to the inquiry D made by the learning guidance device 100 may be responded to simply with a button operation on the stamps 1211 without making any text entry.

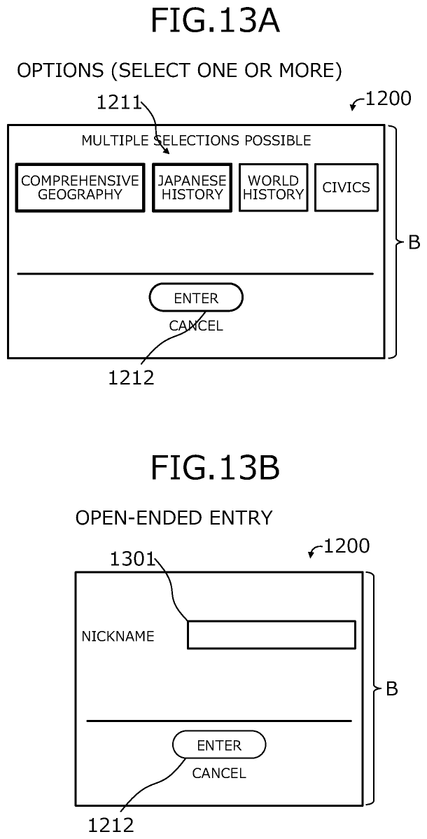

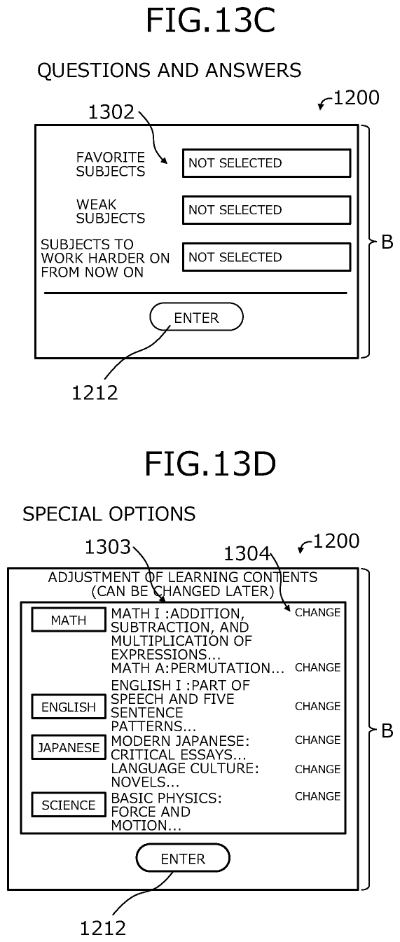

FIGS. 13A, 13B, 13C, and 13D are diagrams depicting examples of chat screens for explaining a user's response supporting function in the learning guidance device. The chatting unit 102a of the learning guidance device 100 selects any one of the chat screens in FIGS. 13A, 13B, 13C, and 13D according to contents of the inquiry D and displays the selected diagram in the response area B.

FIG. 13A is an example of a case where the contents of the inquiry D are the course selection described above and the like and the user responds from response options. In this case, the chatting unit 102a of the learning guidance device 100 displays, in the response area B, multiple stamps 1211 representing courses such as “comprehensive geography” and “Japanese history” corresponding to the inquiry D.

FIG. 13B is an example of a case where the response corresponding to the contents of the inquiry D is an open-ended entry such as a name or a nickname. In this case, the chatting unit 102a of the learning guidance device 100 displays, in the response area B, a text entry field 1301 in which a user makes an open-ended entry corresponding to the inquiry D.

FIG. 13C is an example of a case where the contents of multiple inquiries D are provided and a user responds to these inquiries D from response options for each inquiry, which are “favorite subjects”, “weak subjects”, and “subjects to work harder on from now on”. In this case, the chatting unit 102a of the learning guidance device 100 displays in the response area B, for each inquiry, a pull-down display field 1302 from which a course title set in advance may be selected by a user operation.

FIG. 13D is an example of, for example, a case where adjustment of learning contents for each subject is made regarding the contents of the inquiry D. In this case, the chatting unit 102a of the learning guidance device 100 displays, in the response area B, a course title 1303 of a current learning subject and a change button 1304 to “change”. Courses to learn may be changed by a user operation of the change button 1304.

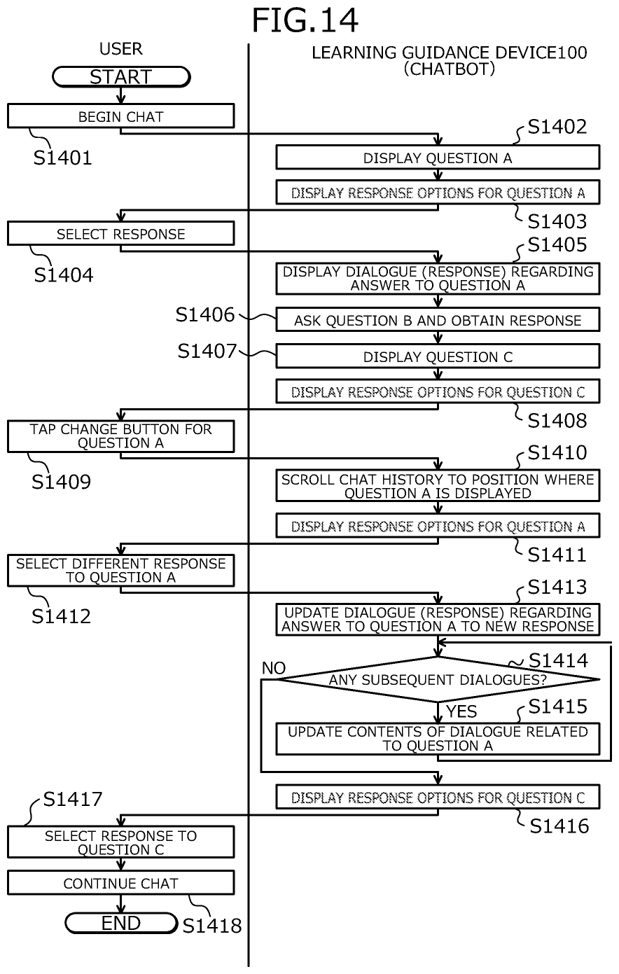

FIG. 14 is a flowchart depicting an example of a chat response amendment process performed by the learning guidance device. FIG. 14 is an example of processing of asking questions to a user, response by the user, and amending the questions mainly performed by the learning guidance device 100 (the chatting unit 102a), FIG. 14 depicts operation contents of the terminal device 111 on the user side and processes on the chatting unit 102a (a chatbot) side based on user operation.

First, when the user begins a chat (step S1401), the learning guidance device 100 displays a question A to the user (step S1402) and displays response options to the question A (step S1403).

With this procedure, the user selects a response to the question A (step S1404), and the learning guidance device 100 displays a dialogue (response) regarding the response to the question A (step S1405). Next, the learning guidance device 100 similarly asks the user a question B and obtains a response from the user (step S1406). Thereafter, the learning guidance device 100 displays a question C (step S1407) and displays response options for the question C (step S1408).

Here, it is assumed that the user taps a change button for the question A to which the user has already responded (step S1409). In this case, the learning guidance device 100 scrolls the history of the chat to the position where the question A is displayed (step S1410) and displays response options to the question A (step S1411).

With this procedure, the user may select and post another response to the question A (step S1412). Subsequently, the learning guidance device 100 updates the dialogue (response) regarding the response to the question A to contents of the new response (step S1413). Further, the learning guidance device 100 determines whether there are any subsequent dialogues (step S1414). When there are subsequent dialogues (step S1414: YES), the learning guidance device 100 updates the contents of the dialogues related to the question A (step S1415) and returns to the process at step S1414. On the other hand, when there is no subsequent dialogue related to the question A (step S1414: NO), the learning guidance device 100 displays response options for the question C (step S1416).

The user selects a response to the question C (step S1417) and thereafter the chat is continued until the final question (step S1418), and the learning guidance device 100 ends the processing described above.

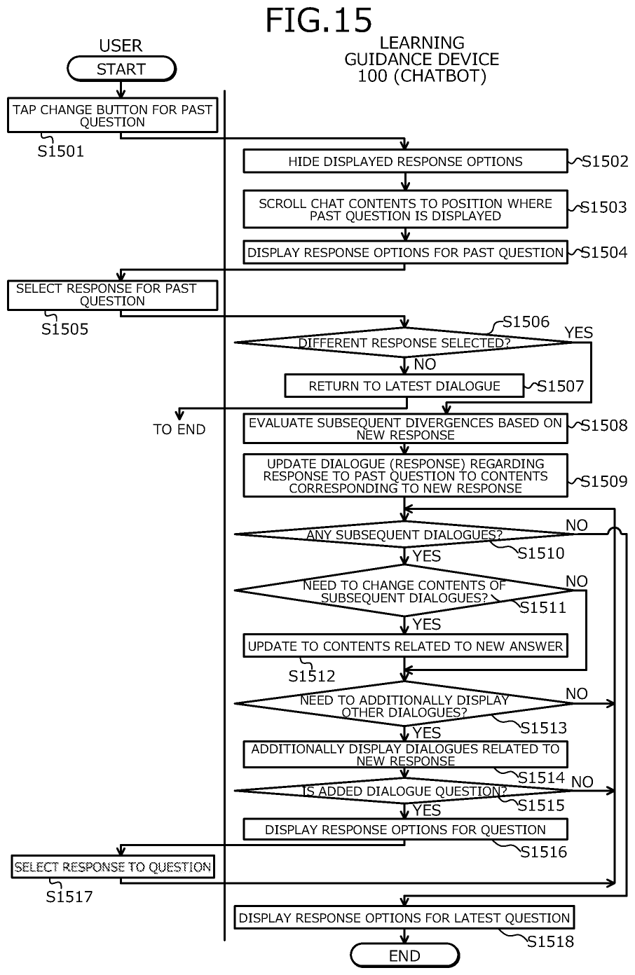

FIG. 15 is a flowchart depicting a specific example of a chat response amendment process performed by the learning guidance device. FIG. 15 depicts a detailed processing example of one process where a user amends a question in the past during display of the latest question.

First, it is assumed that a user taps a change button for a question in the past (step S1501). In this case, the learning guidance device 100 makes currently displayed response options hidden (step S1502) and scrolls the chat contents to a position where the question in the past is displayed (step S1503). Thereafter, the learning guidance device 100 displays response options for an amendment target question (step S1504).

With this procedure, the user selects a response to the amendment target question and posts the response (step S1505). Next, the learning guidance device 100 determines whether another response is selected by the user (step S1506). When another response is selected (step S1506: YES), the learning guidance device 100 proceeds to the process at step S1508. On the other hand, when another response is not selected (step S1506: NO), the learning guidance device 100 returns to processing on the latest dialogue (step S1507) and ends the processing described above.

At step S1508, the learning guidance device 100 evaluates subsequent divergences based on the different (new) response posted by the user (step S1508). In this case, as described above, the learning guidance device 100 re-evaluates contents of subsequent dialogues based on the amended response, for example, and performs processing such as automatically replacing the existing contents with contents reflecting the latest response. Thereafter, the learning guidance device 100 updates the dialogue (response) regarding the response to the amendment target question to contents corresponding to a new response (step S1509).

Next, the learning guidance device 100 determines whether there are any subsequent dialogues (step S1510). When there are subsequent dialogues (step S1510: YES), the learning guidance device 100 determines whether the contents of the subsequent dialogues have to be changed (step S1511). On the other hand, when there is no subsequent dialogue (step S1510: NO), the learning guidance device 100 proceeds to the process at step S1518.

Further, as a result of the determination at step S1511, when the contents of the subsequent dialogues have to be changed (step S1511: YES), the learning guidance device 100 updates the contents to contents related to the new response (step S1512) and proceeds to the process at step S1513. In the process at step S1512, the learning guidance device 100 may eliminate the dialogues themselves. On the other hand, when it is not necessary to change the contents of the subsequent dialogues (step S1511: NO), the learning guidance device 100 proceeds to the process at step S1513.

At step S1513, the learning guidance device 100 determines whether it is necessary to additionally display other dialogues (step S1513). As a result of the determination, when it is necessary to additionally display other dialogues (step S1513: YES), in some instances the number of dialogues increases and according to an increase in the number of dialogues, the learning guidance device 100 additionally displays dialogues related to the new response (step S1514) and proceeds to the process at step S1515. On the other hand, when it is not necessary to additionally display other dialogues (step S1513: NO), the learning guidance device 100 returns to the process at step S1510.

At step S1515, the learning guidance device 100 determines whether an added dialogue is a question (step S1515). As a result of the determination, when the added dialogue is a question (step S1515: YES), the learning guidance device 100 displays response options for the question (step S1516). With this procedure, the user may select a response to the question and post the response (step S1517).

On the other hand, as a result of the determination at step S1515, when the added dialogue is not a question (step S1515: NO), the learning guidance device 100 returns to the process at step S1510.

Thereafter, at step S1518, the learning guidance device 100 displays response options for the latest question (step S1518) and ends the processing described above.

According to the embodiment described above, the learning guidance device obtains, at the time of starting learning, information related to a learning target and a learning subject from a user, calculates a learning volume including a learning time to complete learning the subject within a predetermined total period based on the obtained learning target and the obtained learning subject, and generates a long-term learning plan including a learning time for multiple courses in each of the subjects based on the learning volume. The learning guidance device generates a short-term plan in which, based on the generated long-term plan, a learning time predicted for each course in the subject, in a predetermined period shorter than that of the long-term plan is calculated. The learning guidance device presents, to the user, courses in the subject to learn daily, based on the short-term plan. The learning guidance device calculates a difference of the learning time predicted and an actual learning time, calculates a learning time necessary to complete learning within the total period according to a learning status of the user, and adjusts the courses in the short-term plan and a learning time for each of the courses in the predetermined period. With this configuration, learning is completed within the total period and a predetermined effect of learning may be gained. When the total period is long, there may be a case where learning cannot be carried out according to the long-term learning plan due to a change of the learning status of the user; however, by generating a short-term plan implemented by dividing a long-term plan into short periods and presenting daily learning courses from the short-term plan, a review of learning may be made in each predetermined period in the short-term plan. By adjusting the learning time according to the learning status of the user in the review, learning may be completed within the total period and a predetermined effect of learning may be gained. With this configuration, learning guidance suitable to the learner's learning performance may be realized.

Configuration may be such that the learning guidance device inquires the user of the learning status, obtains a response from the user, and adjusts the courses to learn in the short-term plan at subsequent stages and the learning time for each of the courses, based on an obtained response from the user. In this manner, by making a dialogue regarding the learning status with the user, a short-term plan to be presented to the user at subsequent stages may be a plan that matches the learning status of the user.

The learning guidance device may sequentially present contents of an inquiry set in advance and contents of a response corresponding to the inquiry to the user to obtain the learning status. For example, by using a chatbot, necessary responses as the learning status may be easily obtained through a chat with the user.

The learning guidance device may present a learning pace record including a difference of the learning time predicted and an actual learning time, to the user in the predetermined period. Subsequently, the learning guidance device may predict a learning completion date for each of the courses based on the learning pace record and when there is delay with respect to the total period, present an increase in the learning time to the user, and decide whether there is an increase in the learning time according to whether the user has increased the learning time. With this configuration, the learning guidance device may present a difference of the learning time predicted and an actual learning time to the user in each predetermined period in a short-term plan. Further, upon the user's confirmation, when there is a delay in learning, by increasing the learning time, the learning may be completed within the total period.

The learning guidance device may switch the courses to time effective courses when there is delay greater than a predetermined amount with respect to the total period. With this switching of courses, learning may be completed within the total period.

The learning guidance device may attach a difficulty level in learning to each of the courses and accumulate learning performances of the user by carrying out the learning. In response to a delay or advancement with respect to the total period, the learning guidance device may switch the courses to courses having the difficulty level corresponding to the learning performance of the user. With this configuration, it is possible to guide the user to learn via courses suited to the learning performance of the user and thereby improve the user's effect of learning and enable the user to complete the learning within the total period.

When the learning volume is not more than a predetermined learning volume, the learning guidance device may reselect courses so that the predetermined learning volume is reached for the predetermined period. With this configuration, the learning guidance device enables the user to learn courses with the most suitable volume and complete the learning within the total period.

The learning guidance device sequentially presents, to the user, contents of an inquiry set in a chatbot in advance and contents of a response corresponding to the inquiry to accumulate histories of the obtained inquiry and the obtained response as the learning status. The learning guidance device then displays a change button for each response, whereby the user is able to amend a response so that, when the user operates the change button, the user may amend a corresponding response by tracing back to a response in the past corresponding to the amendment operation by the user via the change button. By using a chatbot, necessary responses as the learning status may be easily obtained through a chat with the user. Further, for a previous chat, the user may amend responses selected from a history and through the amendment of the responses, the user may thoroughly notify the learning guidance device of the user's constantly changing learning status.

The learning guidance device may adjust courses to learn in the short-term plan at subsequent stages and a learning time for each of the courses based on amendment of a response made by the user. With this configuration, the user may learn courses within a learning time adjusted to match the constantly changing learning status of the user and thereby complete the learning within the total period.

The learning guidance device may display, to the user, multiple options for the response corresponding to the contents of the inquiry in a selectable manner, by setting the chatbot in advance. With this configuration, the user can respond to an inquiry with an operation as simple as possible.

The method according to the learning guidance described in the present embodiment may be implemented by executing a prepared program on a computer such as a personal computer and a workstation. The program is stored on a non-transitory, computer-readable recording medium such as a semiconductor memory, a hard disk, a flexible disk, a CD-ROM, a DVD, etc., read out from the computer-readable medium, and executed by the computer. The program may be distributed through a network such as the Internet.

The present invention achieves an effect in that optimal learning guidance matching a user's learning target and daily learning status may be performed.

The learning guidance program, the learning guidance method, and the learning guidance device according to the present invention are useful respectively as a learning guidance program, a learning guidance method, and a learning guidance device for supporting learning in school education, correspondence education, tutoring-school education, and the like, and are particularly suitable respectively to a learning guidance program, a learning guidance method, and a learning guidance device for supporting independent learning of students.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium storing therein a learning guidance program that causes a computer to execute a process, the process comprising:
obtaining, at a time of starting learning, information related to a learning target and a plurality of learning subjects from a user;
calculating, based on the obtained learning target and the obtained learning subjects, a learning volume including a first learning time to complete learning each of the subjects within a total period and generating, based on the learning volume, a long-term learning plan including the first learning time for a plurality of courses in each of the subjects;
generating, for each of the courses, a short-term plan in which, based on the generated long-term plan, a second learning time predicted for each of the courses, for a predetermined period shorter than that of the long-term plan is calculated;
presenting, to the user, the courses in the subject to learn daily, based on the short-term plan; and
calculating, in each predetermined period, a difference of the second learning time and an actual learning time, calculating, according to a learning status of the user, a third learning time necessary to complete the learning within the total period, and adjusting the courses in the short-term plan and the second learning time for each of the courses.

2. The computer-readable recording medium according to claim 1, wherein
the obtaining includes making an inquiry about the learning status to the user and obtaining a response from the user, and
the adjusting includes adjusting the courses to learn in the short-term plan at subsequent stages and the second learning time for each of the courses, based on the response obtained from the user.

3. The computer-readable recording medium according to claim 2, wherein the obtaining includes sequentially presenting, to the user, contents of the inquiry set in advance and contents of the response corresponding to the inquiry to thereby obtain the learning status.

4. The computer-readable recording medium according to claim 2, wherein
the presenting includes presenting, to the user in the predetermined period, a learning pace record including the difference of the second learning time predicted and the actual learning time, and
the adjusting includes predicting a learning completion date for each of the courses, based on the learning pace record and when there is a delay with respect to the total period, presenting an increase in the second learning time to the user, and determining whether there is an increase in the learning time according to whether the user has increased the learning time.

5. The computer-readable recording medium according to claim 4, wherein the adjusting includes switching the courses to time effective courses when there is delay greater than a predetermined amount with respect to the total period.

6. The computer-readable recording medium according to claim 4, further comprising:
attaching a difficulty level in learning to each of the courses; and
accumulating learning performances of the user by carrying out the learning, wherein
the adjusting includes switching the courses to courses having the difficulty level corresponding to the learning performance of the user, corresponding to delay or advancement with respect to the total period.

7. The computer-readable recording medium according to claim 4, wherein, when the learning volume is not more than a predetermined learning volume, the adjusting includes reselecting the courses so that the predetermined learning volume for the predetermined period is reached.

8. The computer-readable recording medium according to claim 1, wherein
the obtaining includes:
sequentially presenting, to the user, contents of an inquiry set in a chatbot in advance and contents of a response corresponding to the inquiry and thereby accumulating histories of the obtained inquiry and the obtained response as the learning status,
displaying, for each response, a change button enabling the user to amend the response, and
when the user operates the change button, amending the response by tracing back to the response corresponding to the change button operated by the user.

9. The computer-readable recording medium program according to claim 8, wherein the adjusting includes adjusting the courses to learn in the short-term plan at subsequent stages and the second learning time for each of the courses, based on amendment of the response made by the user.

10. The computer-readable recording medium according to claim 8, wherein the obtaining includes displaying, to the user, a plurality of options for the response corresponding to the contents of the inquiry, the plurality of options being displayed in a selectable manner by setting the chatbot in advance.

11. A learning guidance method executed by a computer, the method comprising:
obtaining, at a time of starting learning, information related to a learning target and a plurality of learning subjects from a user;
calculating, based on the obtained learning target and the obtained learning subjects, a learning volume including a first learning time to complete learning each of the subjects within a total period and generating, based on the learning volume, a long-term learning plan including the first learning time for a plurality of courses in each of the subjects;
generating, for each of the courses, a short-term plan in which, based on the generated long-term plan, a second learning time predicted for each of the courses, for a predetermined period shorter than that of the long-term plan is calculated;
presenting, to the user, the courses in the subject to learn daily, based on the short-term plan; and
calculating, in each predetermined period, a difference of the second learning time and an actual learning time, calculating, according to a learning status of the user, a third learning time necessary to complete the learning within the total period, and adjusting the courses in the short-term plan and the second learning time for each of the courses.

12. A learning guidance device, comprising:
a memory; and
a processor coupled to the memory, the processor being configured to:
obtain, at a time of starting learning, information related to a learning target and a plurality of learning subjects from a user;
calculate, based on the obtained learning target and the obtained learning subjects, a learning volume including a first learning time to complete learning each of the subjects within a total period and generate, based on the learning volume, a long-term learning plan including the first learning time for a plurality of courses in each of the subjects;
generate, for each of the courses, a short-term plan in which, based on the generated long-term plan, a second learning time predicted for each of the courses, for a predetermined period shorter than that of the long-term plan, is calculated;
present, to the user, the courses in the subject to learn daily, based on the short-term plan; and
calculate, in each predetermined period, a difference of the second learning time and an actual learning time, calculate, according to a learning status of the user, a third learning time necessary to complete the learning within the total period, and adjusting the courses in the short-term plan and the second learning time for each of the courses.
